(19) United States
(12) Patent Application Publication
(10) Pub. No.: US 2013/0088194 A1
(43) Pub. Date: Apr. 11, 2013

(54) OVERHEAD POWER TRANSFER SYSTEM

(71) Applicants: Ian W. HUNTER, Lincoln, MA (US); Serge LAFONTAINE, Lincoln, MA (US); Brian D. HEMOND, Cambridge, MA (US); Keith V. DURAND, Somerville, MA (US)

(72) Inventors: Ian W. HUNTER, Lincoln, MA (US); Serge LAFONTAINE, Lincoln, MA (US); Brian D. HEMOND, Cambridge, MA (US); Keith V. DURAND, Somerville, MA (US)

(73) Assignee: NUCLEUS SCIENTIFIC, INC., Lincoln, MA (US)

(21) Appl. No.: 13/587,362

(22) Filed: Aug. 16, 2012

Related U.S. Application Data
(60) Provisional application No. 61/524,081, filed on Aug. 16, 2011.

(51) Int. Cl. H02J 7/00

(52) U.S. Cl. CPC H02J 7/0027
USPC 320/108; 320/137

(57) ABSTRACT

The present invention relates to a charging station for charging a plurality of vehicles and methods of charging energy storage systems within a plurality of vehicles. A charging station for charging a plurality of vehicles each with a receiver coil located on top of a vehicle, includes: a first and second support structures, an overhead track stretching between the first and second support structures, a movable carriage on the overhead track, the carriage including a transmitter coil located at a position under the carriage for transferring power to the receiver coils of the plurality of vehicles when they are parked under the overhead track and an inductive power transfer module connected to the transmitter coil, and a motorized transport mechanism for moving the carriage along the tracks and positioning the carriage over any selectable one of the plurality of vehicles.

### CROSS-REFERENCE TO RELATED APPLICATIONS

This application claims the benefit or priority to U.S. Provisional Application No. 61/524,081, filed Aug. 16, 2011, the entire disclosure of which is hereby incorporated by reference in its entirety.

### TECHNICAL FIELD

This invention generally relates to a system and method for charging power storage systems in electric vehicles.

### BACKGROUND OF THE INVENTION

As the electric motor and battery charging technology advances, the market for electric vehicles continues to grow. Owners of fleets are beginning to look to electric vehicles as desirable purchases. This means that there will be a need by these fleet owners to install the infrastructure that enables them to recharge the batteries of a large number of vehicles each night. That infrastructure can represent a substantial capital investment.

An increasingly popular approach being advocated by players in the electric vehicle industry involves using wireless energy transfer or inductive power transfer to charge the vehicle's batteries. Examples of such an approach are described in U.S. Pat. Pub. No. 2010/0277121, entitled “Wireless Energy Transfer Between A Source and A Vehicle,” and incorporated herein by reference. In general, the charging station has a transmitting coil, typically installed in the floor of the charging station. And the vehicle includes a receiving coil mounted on its underside. When recharging of the batteries is desired, the driver moves the vehicle into the charging station so that the vehicle's receiving coil is aligned over the transmitting coil. With the two coils aligned in this way, the charging station applies a high frequency (e.g. RF) energy signal to the transmitter coil and energy is transferred to the receiving coil through resonant coupling of the two coils.

### SUMMARY OF THE INVENTION

In general, in one aspect, the invention features a charging station for charging a plurality of vehicles each with a receiver inductor coil located on top of the vehicle. The system includes: first and second support structures; an overhead track stretching between the first and second support structures; a movable carriage on the overhead track, the carriage including a transmitter inductor coil located at a position under the carriage for transferring power to the receiver inductor coils of the plurality of vehicles when the plurality of vehicles is parked under the overhead track, an inductive power transfer module connected to the transmitter inductor coil, and an alignment stage controlling the position of the transmitter inductor coil with respect to the carriage; and a motorized transport mechanism for moving the carriage along the tracks and positioning the carriage over any selectable one of the plurality of vehicles.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a schematic representation of an overhead inductive power transfer system for sequentially charging the storage batteries in a fleet of electric vehicles.

FIG. 2 is a block diagram of the circuitry within the carriage shown in FIG. 2.

### DETAILED DESCRIPTION

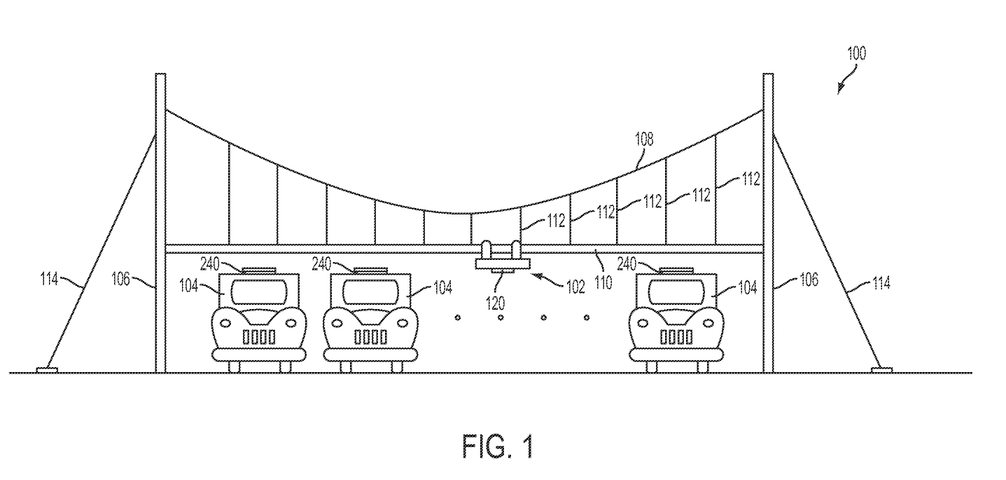

FIG. 1 shows an automated vehicle charging system 100 that is particularly useful for fleet owners. The system enables one to sequentially charge a fleet of vehicles through an overhead charging unit that wirelessly transfers energy to each of the vehicles in succession. The system takes advantage of the ability of current charging technology to fully charge a vehicle's batteries in a matter of minutes rather than the hours that were previously necessary. The faster charging enables one to use a single charging unit to sequentially recharge each vehicle in the fleet of vehicles and still complete the job within a reasonable amount of time, e.g. while the vehicles are parked overnight. This design substantially reduces the amount of capital investment that is required to build a charging facility that can effectively charge multiple vehicles. Rather than having to install a separate, individual charging station for each vehicle, this design enables the fleet owner to install one charging station that is moved from one vehicle to the next in an automated way.

Vehicle charging system 100 includes an overhead structure on which a charging carriage 102 is suspended above a group of vehicles 104 parked under the structure. On the underside of carriage 102 there is a transmitter coil 120 and on the top of each vehicle there is a receiver coil 240 at a height just below the height of transmitter coil 120. In the described embodiment, the overhead structure is similar in the design to that of a suspension bridge. It includes two support towers 106 between which two suspension cables 108 are stretched (in the side view of FIG. 1, only one cable 108 is shown, the other one is parallel to and behind it in the figure). Each of suspension cables 108 supports a corresponding track 110 (e.g. a cable or rail) which is suspended from suspension cable 108 by multiple vertical suspender elements 112 (e.g. other lengths of cable or rods). Further support for towers 106 is provided by support cables 114 that counteract the lateral force exerted on towers 106 by the structure suspended between them. With this arrangement, tracks 110 are arranged to be horizontal to and at a constant height from the ground sufficient to permit the vehicles 104 to be parked under the suspended carriage 102.

Carriage 102 hangs from tracks 110 so that it can move back and forth along the tracks between the two towers. In the described embodiment, the mechanism by which carriage 102 hangs from the tracks is similar to that which is employed in ski lifts. For example, one wheel rides on top of the track and a second wheel, below the first wheel, rides under the track and prevents the carriage from being easily derailed.

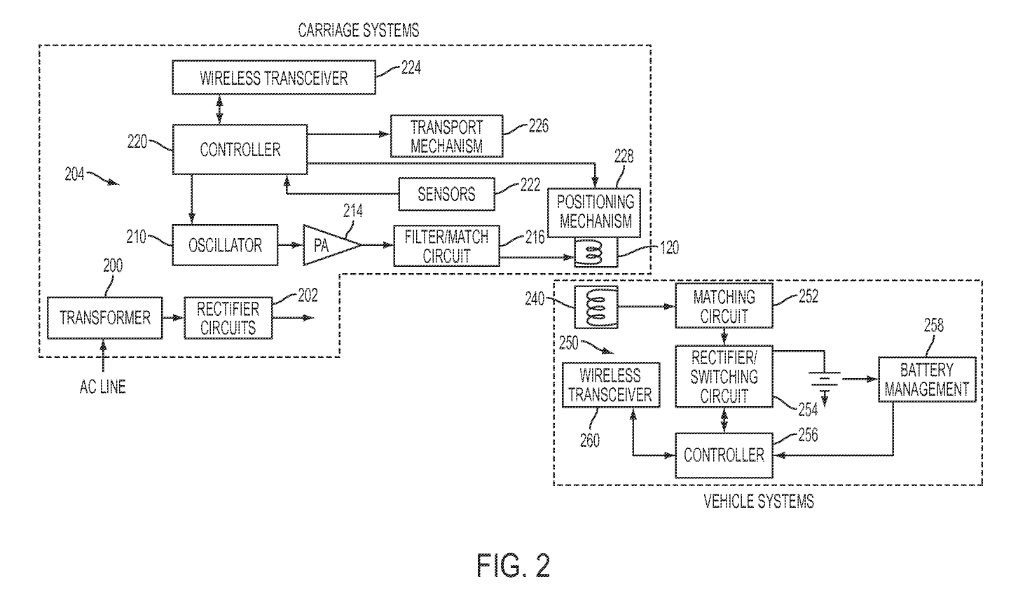

Carriage 102 supports the circuitry necessary to enable energy transfer through transmitter coil 120. Such circuitry is well known to persons skilled in the art and can take a variety of different forms, some examples of which are described in previously-mentioned U.S. Pat. Pub. No. 2010/0277121. In the described embodiment, as shown in FIG. 2, it includes a step-down transformer 200, rectifier circuitry 202, and transmitter circuitry 204. Power is delivered to carriage 102 through high voltage AC lines (e.g. 13.5 kV). Step-down transformer 200 reduces that voltage to a lower level, namely, one that is more compatible with the other circuitry in carriage 102. Rectifier circuitry 202 converts the AC to DC for powering the rest of the circuitry in carriage 102. And transmitter circuitry 204 generates the high frequency power signal for driving transmitter coil 120 and performing inductive power transfer to the vehicle.

This circuitry includes a variable oscillator 210 that is controlled by a control signal 212, a power amplifier 214 connected to oscillator 210, and a filter and matching circuit 216 the output of which is connected to transmitter coil 120. Oscillator 210, which in the described embodiment operates in the RF range (e.g. 13.5 MHz), drives power amplifier 214. The output of amplifier 214 passes through filter and matching circuit 216 which eliminates any noise or unwanted harmonics from the output signal of power amplifier 214 and matches the impedance of the transmitter circuit to the coil to thereby aiding in optimizing the coupling of the amplified RF signal to the receiver circuit in the truck. Controller 220 can also vary the frequency of oscillator 210 to optimize power transfer.

The circuitry in the carriage also includes a processor-based controller 220 for controlling the operation of the various other circuits and systems in carriage 102, sensing circuitry 222 for aiding in physically aligning transmitter coil 120 in carriage 102 with receiving coil 240 in the vehicle, a wireless transceiver 224 for exchanging information with corresponding circuitry located in the vehicle, a transport mechanism or drive motor 226 for moving the carriage along the track, and a coil positioning mechanism 228 made up of an arrangement of servo motors and/or actuators for positioning transmitter coil 120 in more precise alignment with receiver coil 240 in the vehicle.

Controller 220 is programmed to use drive motor 226 to move the carriage along the track from one charging position to another. The program knows roughly where each vehicle coil is located. After achieving initial alignment with the receiver coil in the first vehicle, controller 220 with the aid of sensing circuits 222, that might include various optical and/or mechanical sensors, uses the coil positioning mechanism 228 to more precisely align transmitter coil 120 with receiver coil 240. The sensing circuits are used to optically or electrically detect the precise position of the receiver coil and to cause coil positioning mechanism 228 to physically and electrically align the two coils for optimum power transfer. The motor and/or actuator mechanisms have the ability to move the transmitting coil in three dimensions relative to carriage 102 (two horizontal and one vertical) to achieve the more optimum alignment of the two coils. Controller 220 may also measure the transfer electrical characteristics of the transmitter circuit and dynamically tune the transmitter circuit to achieve the optimum coupling. This can involve receiving feedback from the target vehicle through the wireless communication link established between the two wireless transceivers.

In the vehicle, the receiver coil 240 is connected to a receiver circuit 250. This receiver circuit generally includes a matching circuit 252, a rectifier and switching circuit 254, a controller 256, and a battery management module 258. The signal from the transmitter circuit is resonantly coupled to coil 240 connected to receiver circuit 250. Matching network 252 matches the impedance of the receiver to receiver coil 240. And rectifier and switching circuit 254 rectifies the received AC signal to output a DC voltage that is delivered to the vehicle batteries to carry out the recharging operation. Battery management module 258 monitors the charging of the batteries in the vehicle and provides this information to controller 256 which uses a wireless transceiver 260 to communicate certain monitored information to wireless transceiver 224 in carriage 102.

Under tracks 110, there is a row of identified parking spaces or slots into which the vehicles are driven for overnight charging. The slots are physically identified on the parking surface and indentations in the parking surface into which the wheels are positioned provide a rough alignment of the vehicles under tracks 110. When carriage 102 moves back and forth under track, it will bring transmitter coil 120 into approximate alignment with receiver coils 240 on top of the vehicles.

When the charging sequence is initiated, controller 220 in the overhead carriage 102 causes drive motor 226 to move carriage 102 along tracks 110 to a start position on one side and above the location where the first vehicle is located. At that location, controller 220 uses sensing circuitry 222 to find receiver coil 240 with which it will need to align transmitter coil 120. Then, controller 220 uses positioning mechanism 228 within carriage to align transmitter coil 120 more precisely both horizontally and vertically with respect to the underlying receiver coil 240. Once the two coils are properly aligned, controller 220 begins the power transfer operation to charge the vehicle's batteries.

Controller 256 in the vehicle senses the state of charge of the onboard batteries and detects when they are fully charged. Using the communication link established between the two wireless transceivers 224 and 260, controller 256 communicates the charging status information to controller 220 in carriage 102. When full charge is reached, controller 220 in carriage 102 terminates the charging operation for that vehicle. Then, it cause carriage 102 to move on to the next vehicle and performs the same sequence of steps to charge the batteries of the next vehicle. This sequence is repeated for each vehicle until each vehicle that is parked within the charging structure has been fully charged.

The drive mechanism for moving the carriage along the overhead track was described herein as being located in the overhead carriage. However, it could alternatively be located on the support towers and operate a cable which moves the carriage to the desired locations.

Other embodiments are within the following claims.

What is claimed is:

1. A charging station for charging a plurality of vehicles each with a receiver coil located on top of the vehicle, said system comprising:
first and second support structures;
an overhead track stretching between the first and second support structures;
a movable carriage on the overhead track, said carriage including a transmitter coil located at a position under the carriage for transferring power to the receiver coils of the plurality of vehicles when the plurality of vehicles is parked under the overhead track and an inductive power transfer module connected to the transmitter coil; and
a motorized transport mechanism for moving the carriage along the tracks and positioning the carriage over any selectable one of the plurality of vehicles.

2. The charging station of claim 1, wherein the movable carriage further comprises an alignment stage for movably positioning the transmitter coil with respect to the carriage so as to achieve further alignment with the receiver coil.

3. The charging station of claim 2, wherein the alignment stage for movably positioning the transmitter coil in three dimensions with respect to the carriage.

4. The charging station of claim 1, wherein the carriage is suspended from the track.

5. The charging station of claim 1, wherein the track comprises a cable.

6. The charging station of claim 5, wherein the track comprises two cables parallel with each other.

7. The charging station of claim 1, wherein the track comprises two rails.

8. The charging station of claim 1, wherein the motorized transport mechanism is within the carriage.

9. The charging station of claim 1 wherein the inductive power transfer module comprises a controller for controlling the motor transport mechanism and the transfer of power between the transmitter coil and a receiver coil.

10. A method of charging energy storage systems within a plurality of vehicles each with a receiver coil located on top of the vehicle, said method comprising:
providing an inductive power transfer system for inductively transferring power to a receiver coils;
positioning the inductive power transfer system above a selected one of the plurality of vehicles and in alignment with the receiver coil in that selected vehicle;
after positioning the inductive power transfer system above the selected one of the plurality of vehicles, inductively transferring power from the inductive power transfer system into the selected vehicle through the receiver coil on top of the selected vehicle; and
sequentially repeating the positioning and inductive power transfer steps for each of the remainder of the plurality of vehicles.
